(19) United States
(12) Patent Application Publication
(10) Pub. No.: US 2002/0072290 A1
(43) Pub. Date: Jun. 13, 2002

(54) Sheet material for use in the manufacture of shoes, method of making same and shoe insole

(76) Inventor: Susan Gwynneth Johnson, Botcheston (GB)

Correspondence Address: ROBERT C. NABINGER, Fish & Richardson P.C., 225 Franklin Street, Boston, MA, 02110-2804, US

(21) Appl. No.: 09/952,234

(22) Filed: Sep. 13, 2001

Related U.S. Application Data
(63) Continuation of application No. PCT/GB00/00815, filed on Mar. 7, 2000.

(30) Foreign Application Priority Data
Mar. 13, 1999 (GB) 9905753.1

(51) Int. Cl. B32B 3/00

(52) U.S. Cl. 442/64; 442/65; 442/66; 442/67; 442/71; 442/103; 442/104

(57) ABSTRACT

A sheet material suitable for use in the manufacture of shoes comprising a non-woven fiber fabric having a stiffening thermoformable binder impregnated into and extending inwardly from one surface of the fabric for a depth of more than 0.25 mm and the remaining part of the fabric being impregnated with a resilient rubbery binder and having a lower binder to fiber weight ratio than the region impregnated with the stiffening thermoformable binder. A method of making a material and a shoe insole including the material are also described.

### TECHNICAL FIELD

This invention is concerned with a sheet material suitable for the use in the manufacture of shoes and, especially, for use in the manufacture of a shoe insole, and with a method of making the material.

The term “shoe” where used herein is to be understood as denoting outer footwear generally whether ready for wear or in the course of manufacture.

### BACKGROUND ART

For some purposes, sheet materials having different characteristics in different regions through the material are desirable. For certain types of shoe, an insole with a foot contacting surface which is relatively resilient is desirable to provide a cushion for the foot but, for the manufacture of shoes, the insole requires a degree of rigidity which is not provided by a cushioning material. It has been possible to produce a sheet material with both cushioning and thermoformable properties by laminating two different, separate, materials together one of the materials providing the cushioning properties and the other thermoformable properties. This involves a laminating operation which incurs an additional cost and introduces a risk of the insole delaminating during wear.

Our European Patent No. 0414395 describes a material which is suitable for use in the manufacture of cushion insoles and may be provided with a back-coating to give the material a degree of stiffness. However, such a back-coating, applied as described in our European patent, is primarily a surface coating which penetrates, only about 0.25 mm (less than 10%) into the thickness of the coated material. Whilst this gives the material increased stiffness, the properties are still not altogether satisfactory for use as a structural shoe insole; it can be molded, to some extent, to impart a shape corresponding generally with the contour of the sole of the foot but the back-coated material described in European Patent No. 414395 tends to be too brittle for structural use.

### DISCLOSURE OF THE INVENTION

One of the various objects of the present invention is to provide an improved sheet material suitable for use in the manufacture of shoes.

Another object of the invention is to provide an improved shoe insole.

The invention may be considered to provide a sheet material suitable for use in the manufacture of shoes comprising a non-woven fibre fabric having a stiffening thermoformable binder impregnated into and extending inwardly from one surface of the fabric for a depth of more than 0.25 mm and the remaining part of the fabric being impregnated with a resilient rubbery binder and having a lower binder to fibre weight ratio than the region impregnated with the stiffening thermoformable binder.

The depth of penetration of the thermoformable binder into the fabric depends upon the desired stiffness of the final product, as well as the binder properties. Preferably the stiffening, thermoformable binder extends inwardly for a depth of at least 1 mm into the fabric. More preferably the thermoformable binder extends inwardly for a depth of from 1.5 mm to 3 mm into the fabric: a depth of penetration of at least 1.5 mm appears to be important to provide a desired amount of transverse stiffness to the insole.

In practice, the depth of penetration into the surface will preferably exceed 10% of the thickness of the fabric (prior to impregnation) and not be more than 50% of the thickness. Clearly, where the material is to be suitable for use as a cushion insole, depth of penetration of the thermoformable binder should be chosen to leave a sufficient depth free of the binder to achieve the desired cushioning performance.

Preferably, in a sheet material in accordance with the invention the weight ratio of the thermoformable binder to fibre in the region of the fabric impregnated by the thermoformable binder is from 0.3:1 to 3:1.

Preferably in a sheet material in accordance with the invention a weight ratio of rubbery resilient binder to fibre in the remaining thickness of the fabric is from 0.15:1 to 1.5:1

The binder/fibre ratios for both the thermoformable binder and the rubbery resilient binder are selected according to the properties desired of the regions of the fabric. For example, where the material is intended to be used as a cushion insole, the binder/fibre ratio of the rubbery resilient binder should be sufficient to keep the fibre fabric as an integral mass during wear but not so great that the inherent resilience of the fibre fabric is compromised or the fabric made too stiff to perform effectively as a cushion insole. Where the material is intended for use as a structural shoe insole, in the manufacture of a shoe, the stiffness imparted by the thermoformable binder must be sufficient to withstand the stresses imparted during manufacture of the shoe; where the material is to be used as a cushion insole, introduced into the shoe after manufacture, the rigidity requirements are lower and less thermoformable binder may be necessary.

A preferred sheet material in accordance with the invention includes a fabric which has a thickness of between 3 and 10 mm, the fibres have a decitex between 1.7 and 17 and a staple length between 30 and 80 mm, and the density of the non-woven fibre fabric before impregnation is between 0.01 and 0.1 g\cm³ to (10-100 kg/m³.

In a preferred sheet material the resilient rubbery binder is nitrile rubber and the stiffening thermoformable binder is a thermoformable styrene-butadiene copolymer having a styrene content of about 80%.

In another aspect the invention may be considered to provide a shoe insole, in particular a cushion insole, comprising a sheet material in accordance with the invention.

In another aspect the invention may be considered to provide a me t hod of making a sheet material comprising the following steps:(i)

(i) procuring a non-woven fibre fabric

(ii) impregnating the fabric with a liquid material which when dried provides a resilient rubbery binder

(iii) drying and, if necessary, curing the liquid material to provide a resilient rubbery binder binding the fibres of the fabric together

(iv) after the rubbery binder has dried, applying a coating of a relatively viscous liquid binder composition to one surface of the fabric, this binder composition being such that when dried and, if necessary, cured it provides a stiff thermoformable binder

(v) while the coating is still viscous passing the coated fabric through a gap between a pair of nip rolls, the gap being such that the binder composition is impregnated into the fabric for a depth of more than 0.25 mm and of at least 15% and not more than 50% of the thickness of the uncompressed fibre fabric and

(vi) drying and, if necessary curing, the binder composition.

The gap between the nip rolls in step (v) of a method in accordance with the invention is dependent on the properties of the non-woven fabric and the depth of penetration which is required. Normally the gap between the nip rolls will be less than 50% of the original thickness of uncompressed fabric. Preferably the gap between the nip rolls is preferably less than 25% of the uncompressed thickness of the fabric, conveniently between about 10 and 20%.

Conveniently, in carrying out a method in accordance with the invention the binder composition is coated in step (iv) onto the fabric using a smooth blade supported over a solid block (‘blade over block’) with a gap set to give a coating having a desired coating weight. Instead of the ‘blade over block’ method other coating methods may be used, if desired, for example “blade over air” coating or rotary screen coating, all of which methods are well known to those skilled in the art.

Suitably the wet coating weight of the binder composition is 300-800 grams per square meter.

The viscosity of the wet binder composition is chosen according to the depth of penetration required and to be suitable for the chosen coating technique. Commonly in carrying a method in accordance with the invention the viscosity of the wet binder composition is more than 15,000 c.p.s., suitably about 30,000 c.p.s., when using the ‘blade over block’ method.

There now follows a detailed description, to be read with reference to the accompanying drawing, of a sheet material, a shoe insole and a method of making a sheet material embodying the invention. It will be realised that this sheet material, insole and method have been selected for description by way of example.

### BRIEF DESCRIPTION OF THE DRAWINGS

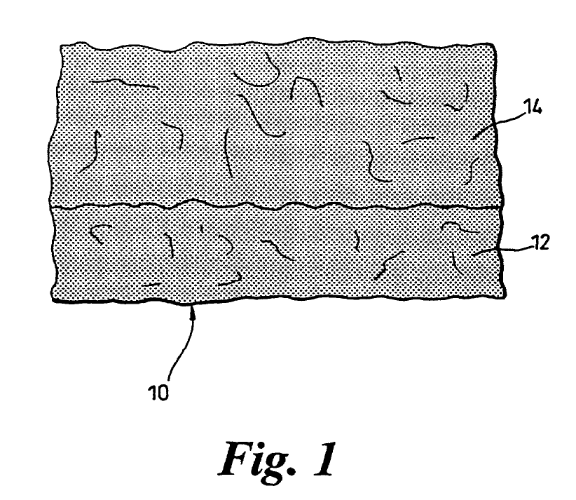

In the accompanying drawing FIG. 1 is a diagrammatic sectional view with parts broken away, showing a sheet material embodying the invention.

### MODES FOR CARRYING OUT THE INVENTION

In carrying out the illustrative method of making the illustrative sheet material, a non-woven textile fibre fabric is first made in a manner well known to those skilled in the art by laying a random batt of textile fibres by any of the known techniques, for example by air laying techniques or by carding and cross-lamping and the batt thus created needled to create a needled non-woven textile fibre fabric. The fibres which were used were 6.7 decitex polyester textile fibres and the weight of the batt was about 750 grams per square meter (gsm).

The thus formed bat was then impregnated with a liquid material which when dried provides a resilient rubbery binder, in this instance a nitrile rubber. The non-woven needled fabric is passed through an impregnating bath containing an aqueous dispersion of nitrile rubber and passed through nips between rollers to remove excess impregnant. The impregnated fabric is subsequently dried. The dilute binder tends to migrate towards the surfaces of the non-woven fabric during drying giving an increased concentration of the nitrile rubber binder at the surface: this increased density can help to provide some extra abrasion resistance at the surfaces but is not essential. The process is arranged so that the weight ratio of nitrile rubber to fibre in the dried impregnated fabric is 0.2:1.

After the fabric impregnated with the nitrile rubber binder has been fully dried, a stiff, thermoformable binder composition is applied to one surface of the fabric the stiff binder composition used is Dow XZ 91070 which is believed to be a styrene-butadiene copolymer binder including 80% styrene; this binder composition was thickened to a viscosity of 30,000 c.p.s. The binder composition was applied to the fabric using a smooth blade supported over a solid block with a gap set above the surface of the non-woven fabric 10 sufficient to provide a wet coating weight on the fabric surface of between 500 and 600 grams per square meter (between 250 and 350 gsm dry weight).

Whilst this binder composition coating was still wet the material was passed between nip rolls with a gap set at approximately 10-20% of the original fabric thickness. The original fabric thickness of the non-woven fabric is about 8.0 mm and the gap between the nip rolls was 1 mm (ie about 12.5%). This results in the relative stiff coating being pressed into a region of the fabric to a depth of about 2.5 mm which is approximately equal to 30% of the dried fabric thickness (the dried thickness is about the same as-the initial fabric thickness ie about 8.0 mm).

The illustrative sheet material therefore has a stiffening, thermoformable binder impregnated into a region 12 of the fabric extending inwardly from one surface 10 of the fabric for a depth of about 30% of the thickness of the fabric and the remaining part 14 of the fabric is impregnated only with the resilient rubbery binder provided by the nitrile rubber. As noted above the binder to fibre weight ratio in the part 14 of the fabric is 0.2:1 and in the region 12 of the fabric impregnated with the stiffening thermoformable binder the binder to fibre weight ratio is approximately 1:1.

The peak deceleration performance of the illustrative material is amongst the best of a wide range of materials currently used as insoles as is, also, its energy return performance although it may not be sufficiently great for high performance athletic footwear. It also has better compression set resistance than many other cushion insole materials.

Whereas the illustrative material utilises a relative coarse fibre and an open, lofty fabric, the invention may also be employed with finer fibres and finer needles to provide a material which is overall rather more dense than the illustrative material. The peak deceleration performance of such a more dense material may not be quite as effective as for the illustrative material and would be primarily suitable for more casual, rather than athletic footwear.

Whereas the illustrative material is made by first impregnating the full thickness of the fibre fabric with a resilient rubbery binder, it will be understood that in making a material in accordance with the invention, different binders may be applied to opposite sides of the non-woven fabric and the distribution of the applied binders controlled whilst wet, for example using pressure applied by nip rollers. Fibre choice, configuration of the base non-woven fabric, binder choice and distribution can give considerable variation in the end product. The control of the level and position of different binders can be achieved by combinations of coatings, impregnation and passing the fabric through a nip, at various stages in a method in accordance with the invention can provide considerable variation in properties of the finished sheet material.

It will be appreciated that the effectiveness of the cushioning in the material will be related to the depth of the stiff, thermoformable binder; the greater the depth of the stiffening binder composition, the less effective as a shock absorber the material will be for any given overall thickness. Where the primary function of the stiffening layer is to impart satisfactory mouldability to fit and support the plantar region of the foot (eg in an insert) then a material in accordance with the invention may not be quite as efficient as an injection/molded foam insert. However, where resistance to lateral compression is required, for example for lasting, then the material in accordance with the invention may offer cost and performance benefits over other systems based upon laminates of foams with stiffening layers.

1. A sheet material suitable for use in the manufacture of shoes comprising a non-woven fibre fabric having a stiffening thermoformable binder impregnated into and extending inwardly from one surface of the fabric for a depth of more than 0.25 mm and the remaining part of the fabric being impregnated with a resilient rubbery binder and having a lower binder to fibre weight ratio than the region impregnated with the stiffening thermoformable binder.

2. A sheet material according to claim 1 wherein the stiffening thermoformable binder penetrates inwardly for a depth of at least 1 mm into the fabric.

3. A sheet material according to claim 1 wherein the stiffening thermoformable binder extends inwardly for a depth of from 1.5 mm to 3 mm into the fabric.

4. A sheet material according to claim 2 wherein the stiffening thermoformable binder extends inwardly for a depth of from 1.5 mm to 3 mm into the fabric

5. A sheet material according to any of claims 1-4, wherein the stiffening thermoformable impregnant extends inwardly for a thickness of not more than 50% of the thickness of the fabric.

6. A sheet material according to claim 1, where the weight ratio of the thermoformable binder to fibre in the region of the fabric impregnated by the thermoformable binder is from 0.3:1 to 3:1.

7. A sheet material according to claim 1, where the weight ration of the rubbery resilient binder to fibre is from 0.15:1 to 1.5:1.

8. A sheet material according to claim 1, where the impregnated fabric has a thickness between 3 mm and 10 mm, the fibres have a decitex between 1.7 and 17 and a staple length between 30 and 80 mm, and the density of the impregnated fabric is between 0.01 and 0.1 g/cm³ (10-100 kg/m³).

9. A sheet material according to claim 1, wherein the resilient rubbery binder is nitrile rubber.

10. A sheet material according to claim 1, wherein the stiffening thermoformable binder is a thermoformable styrene-butadiene copolymer.

11. A shoe insole comprising a sheet material, wherein the sheet material comprises a non-woven fibre fabric having a stiffening thermoformable binder impregnated into and extending inwardly from one surface of the fabric for a depth of more than 0.25 mm and the remaining part of the fabric being impregnated with a resilient rubbery binder and having a lower binder to fibre weight ratio than the region impregnated with the stiffening thermoformable binder.

12. A method of making a sheet material comprising the following steps:
(i) procuring a non-woven fibre fabric
(ii) impregnating the fabric with a liquid material which when dried provides a resilient rubbery binder
(iii) drying and, if necessary, curing the liquid material to provide a resilient rubbery binder binding the fibres of the fabric together
(iv) after the rubbery binder has dried, applying a coating of a relatively viscous liquid binder composition to one surface of the fabric, this binder composition being such that when dried and, if necessary, cured it provides a stiff thermoformable binder
(v) while the coating is still viscous passing the coated fabric through a gap between a pair of nip rolls, the gap being such that the binder composition is impregnated into the fabric for a depth of more than 0.25 mm and
(vi) drying and, if necessary curing, the binder composition.

13. A method according to claim 11 in which the binder composition is impregnated into the fabric for a depth of at least 1 mm.

14. A method according to claim 11 wherein the binder composition is impregnated into the fabric for a depth of from 1.5 to 3 mm.

15. A method according to any one of the claims 11 and 13 wherein the wet weight of the binder composition is 300-800 grams per square meter.

16. A method according to any one of claims 11 to 13 wherein the gap between the nip rolls is less than 25% of the uncompressed thickness of the fabric.

17. A method according to any one of claims 11 to 13 wherein the viscosity of the wet binder composition is at least 15,000 c.p.s.
